(19) United States
(12) Patent Application Publication
(10) Pub. No.: US 2007/0080247 A1
(43) Pub. Date: Apr. 12, 2007

(54) Walk behind sprayer

(76) Inventor: Jason Ticknor, Naples, FL (US)

Correspondence Address: LITMAN LAW OFFICES, LTD, PO BOX 15035, CRYSTAL CITY STATION, ARLINGTON, VA, 22215, US

(21) Appl. No.: 11/543,964

(22) Filed: Oct. 6, 2006

Related U.S. Application Data
(60) Provisional application No. 60/723,912, filed on Oct. 6, 2005.

(51) Int. Cl. B05B 3/18

(52) U.S. Cl. 239/754; 239/168; 239/166

(57) ABSTRACT

The walk behind sprayer is a manually propelled sprayer for treating golf course greens, fairways, lawns and farmland with chemical agents. The sprayer avoids the need to ride through its own freshly deposited chemical spray. The boom of the sprayer is designed to distribute the chemical agent in a preferred pattern and then fold in upon itself for transportation. The boom supports the spray heads that are connected by tubing to the combined on-off trigger handle and connected by tubing and hose to a supply of liquid chemical. The pushing function and boom positioning functions are separate and are designed to operate independently. A pressure gauge and speedometer allow the operator to carefully monitor application of chemical(s).

### CROSS-REFERENCE TO RELATED APPLICATION

This application claims the benefit of U.S. Provisional Patent Application Ser. No. 60/723,912, filed Oct. 6, 2005.

### BACKGROUND OF THE INVENTION

1. Field of the Invention

The present invention relates to manually propelled sprayers for chemically treating golf courses, lawns and farmland with liquids. The invention particularly relates to a walk behind sprayer with a fixed pusher handle and spray boom positioned in back of the wheels in combination with a matching trailer to transport the sprayer, and a pressure gauge and simple, multi-function speedometer to monitor operation of the sprayer.

2. Description of the Related Art

Manually propelled liquid sprayers are commonly used in agricultural applications to treat golf greens and fairways, large public and private lawns, and farmlands with chemical liquid insecticides, weed killers, fertilizer and the like. They are relatively lightweight coated steel apparatuses built on a triangulated chassis supported by three wide, soft rubber wheels. The chemical agent is pumped to the sprayer via a hose from a remote container, usually transported to the spraying site by truck.

The chemical agent supply hose is connected by tubing to a laterally collapsible pipe boom, which, when extended, spreads preferably from seven to nine feet and contains a number of liquid spray nozzles. The pattern of the spray onto the golf green or lawn is determined by the height of the spray nozzles above the ground, the distance between nozzles, the nozzle type, and the type of aperture that emits liquid from the nozzles under pressure. Care must be taken to adjust the liquid spray pattern to one that assures that the preferred amount of liquid chemical agent is deposited uniformly onto the grass or ground. The pattern of the spray on the ground may be adjusted by raising or lowering the extended boom, and adjusting the distance between the nozzles. In conventional sprayers, the boom is connected at its midpoint to a long hinged post that is connected to the frame of the sprayer and traverses obliquely toward the rear of the apparatus, where it supports the operators handle and feed trigger. The operator, while traveling over hills large and small, must raise and lower the handle repeatedly to maintain a suitable spray pattern. Repeatedly adjusting the spray pattern while pushing the sprayer at a strong walk is an ergonomically tasking job, which complicates the challenge of maintaining a suitable spray pattern.

In conventional sprayers, the extended boom is positioned forward of the wheels while spraying. As a result, the wheels of the sprayer are manually pushed through the wet, freshly treated grass or soil containing the chemical agent. Consequently, even with a correct spray pattern, the dosing of the chemical agent on the grass is disturbed, which may lead to patterns of overdosing and underdosing on the sprayed area.

Thus, a walk behind sprayer solving the aforementioned problems is desired.

### SUMMARY OF THE INVENTION

The walk behind sprayer is a manually propelled sprayer for treating golf course greens, fairways, lawns and farmland that does not require the sprayer to ride through its own freshly deposited chemical spray. The boom of the sprayer is designed to distribute the chemical agent in a preferred pattern and then fold in upon itself for transportation. The boom supports the spray heads that are connected by tubing to the combined on-off trigger handle and connected by tubing and hose to a supply of liquid chemical. The boom is attached to the chassis behind the wheels of the sprayer and thereby is not compelled to pass through freshly deposited chemical agents.

In addition, the pushing function and boom positioning function have been separated and are designed to operate independently. The boom, and consequently the spray pattern, can be raised or lowered without altering the position of the handle the operator uses to push the sprayer and trigger the release of the liquid spray. Thus, the sprayer that is easier for the operator to push while applying a more consistently accurate amount of chemical agent to the grass or soil without tire patterns.

Since the walk behind sprayer is intended to be light and propelled by being pushed by an operator, the apparatus has a relatively light, open chassis comprising interconnecting metal tubing, preferably steel, supported at three points on two axles: a pivoting short forward axle for holding one or two wide tread tires, and a fixed long axle having a wide tread tire at each end of the axle positioned near the midpoint of the chassis. The lightweight and easy, accurate operation of the sprayer advantageous when treating showcase lawns and golf greens. The fact that the reservoir of chemical agent is remote from the sprayer removes that weight from the sprayer and avoids the propensity for weighty sprayers to rut the lawns or green. The fact that the sprayer boom is behind the wheels assures better traction for the sprayer wheels and a lessened risk of harmful skidding on rolling greens and lawns.

Additionally, a pressure gauge is provided to monitor the spray rate, which is set by the chemical's manufacturer, and a simple, multi-function speedometer is provided, which allows the operator to maintain a constant speed, monitor the total distance traveled, and also provide a service timer, which alerts the operator as to the appropriate time to perform service on the sprayer.

These and other features of the present invention will become readily apparent upon further review of the following specification and drawings.

### BRIEF DESCRIPTION OF THE DRAWINGS

FIG. 1 is a front, right perspective of the walk behind sprayer according to the present invention.

FIG. 2 is a front, left perspective of the walk behind sprayer according to the present invention.

FIG. 3 is front perspective of the sprayer of the walk behind sprayer according to the present invention with the boom folded.

FIG. 4 is a rear perspective of the walk behind sprayer according to the present invention with the boom folded.

FIG. 5 is a front-left perspective of a walk behind sprayer trailer according to the present invention.

FIG. 6 is a perspective view of a suitable speedometer used with and according to the present invention.

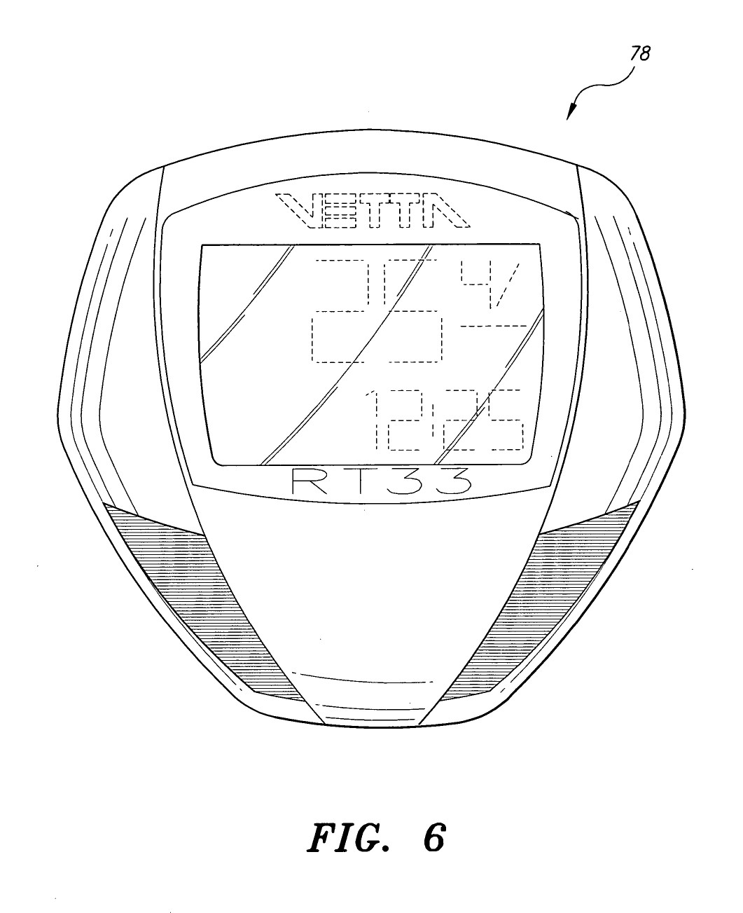

Similar reference characters denote corresponding features consistently throughout the attached drawings.

### DETAILED DESCRIPTION OF THE PREFERRED EMBODIMENT

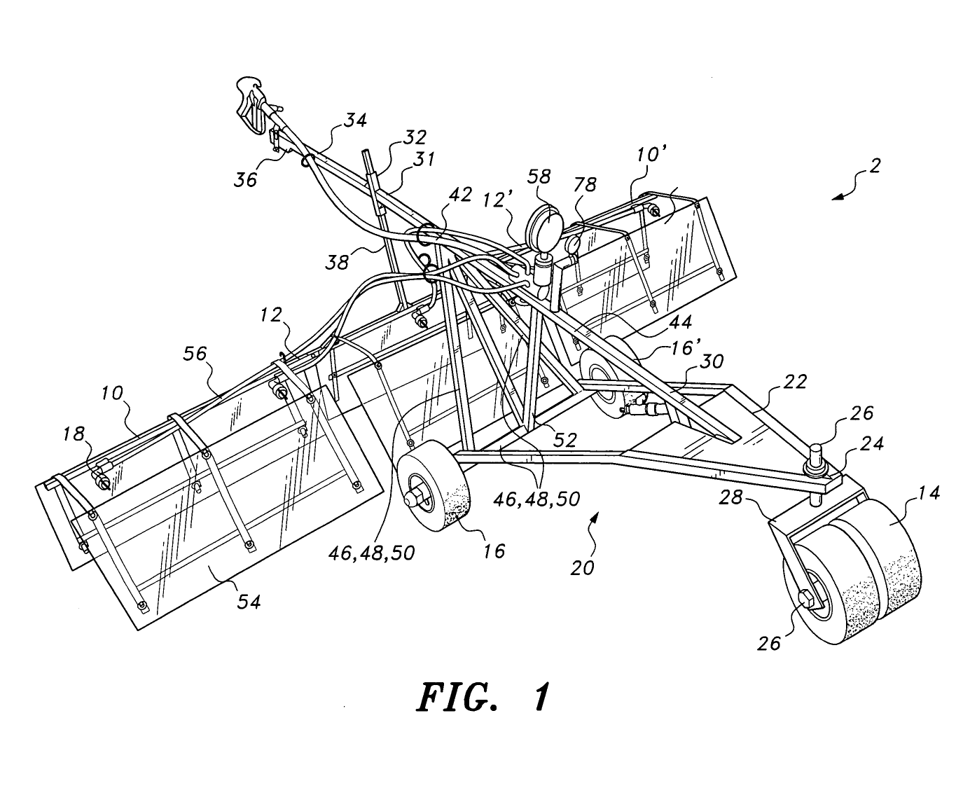

Referring to FIG. 1, a preferred embodiment of the walk behind sprayer 2 of the present invention is shown presented with the boom 10 and 10′ containing a plurality of spray nozzles 18, the boom extending through hinged joints 12 and 12′ for application of chemical agents.

The sprayer 2 rests stationary on three axle-supported tires connected to the load bearing chassis 20. The front tire(s) 14 and middle tires 16 and 16′ are selected for their high load bearing and anti-skid properties. The forward portion of the chassis consists of an essentially level, triangle plate 22 having an aperture 24 at the apex to admit a rotatable shaft 26 connected to the front tire(s) axle 26 through frame 28. A long, preferably hollow and rectangular shaft 30 rises at a fixed angle substantially less than 90° and terminates above the midpoint of the boom 10. At the termination point 31, the shaft 30 is connected to an exterior side of a short, hollow box shaft 32. At a side opposite to exterior side 31, shaft 34 of the fixed handle 36 of the apparatus is connected. Another shaft 38 having means for raising and lowering the boom is partially passed through the hollow box shaft 32 and connected to the midpoint 40 of the boom 10.

Proceeding with the description of the sprayer of FIG. 1, a triangulated open frame segment of the chassis is connected to the long, hollow shaft 30 at point 42, i.e., the apex of the triangle formed by 46, 48 and 50; and at 44, which is the intersection of shaft 52 with the hollow shaft 30. The shaft or rod 50 is non-rotatable or fixed, and connects the rotating wheels 16 and 16′. The rod 50 is also connected to the opposing end of shaft 52. Referring to the boom 10 of FIG. 1, during spraying operations the boom is covered with a clear plastic covering 54 to prevent the wind from disturbing the spray pattern and to protect the operator from getting wet from spray. The chemical agent is distributed to the spray heads by tubing 56.

A pressure gauge 58 and a speedometer 78 are provided, and mounted so as to be clearly visible to the operator. The pressure gauge 58 helps the operator control the spray rate which is set by the chemical's manufacturer. A relatively simple, multi-function speedometer 78 also helps regulate the spray rate, in that it allows the operator to maintain a constant speed, and monitor the total distance traveled. Also, the speedometer 78 provides a service timer to allow the operator to be adequately advised when it is necessary to perform routine maintenance on the sprayer. One suitable such speedometer could be the Vetta model RT33, ordinarily intended for recreational cyclists. In addition to speed, trip distance and cumulative odometer readings, the Vetta RT33 includes a 12/24 hour clock, an auto stop and start function, and a service timer. The Vetta RT33 is available in the US through Acumen, Inc., 101A Executive Drive, Suite 100, Sterling VA 20166.

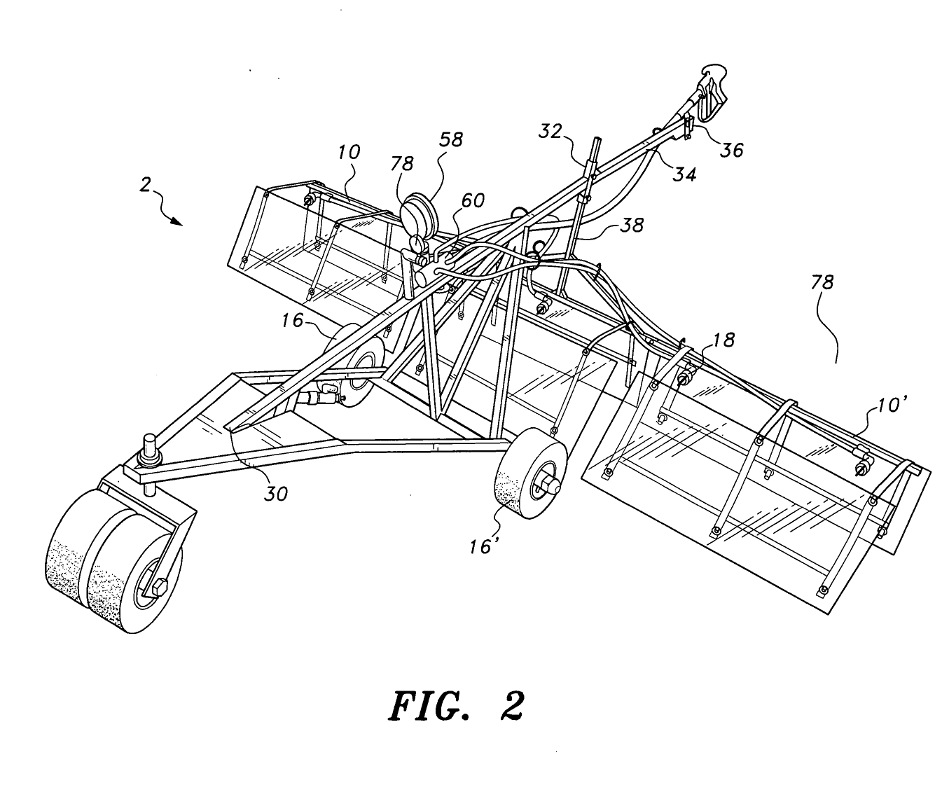

Referring to FIG. 2, the apparatus of FIG. 1 is presented in a front, left perspective. The sprayer 2 is shown with the boom 1 0 and 10′ extended behind the wheels 16 and 16′ to deposit the chemical agent without the wheels passing through the freshly sprayed grass. The boom 10 and 10′ can be raised or lowered to adjust the spray pattern by raising or lowering the shaft 38 independent of the position of the fixed handle 36. This is enabled by allowing the passage of the height-adjusting rod 38 through the box shaft 32 independent of the position of the fixed handle, while the fixed handle shaft 34 and associated long shaft 30 are connected to the proximate exterior front and rear sides of the box shaft 32. The chemical agent to be sprayed is introduced from a remote reservoir into the fluid header 60 and passed to the spray heads 18 by tubing 56.

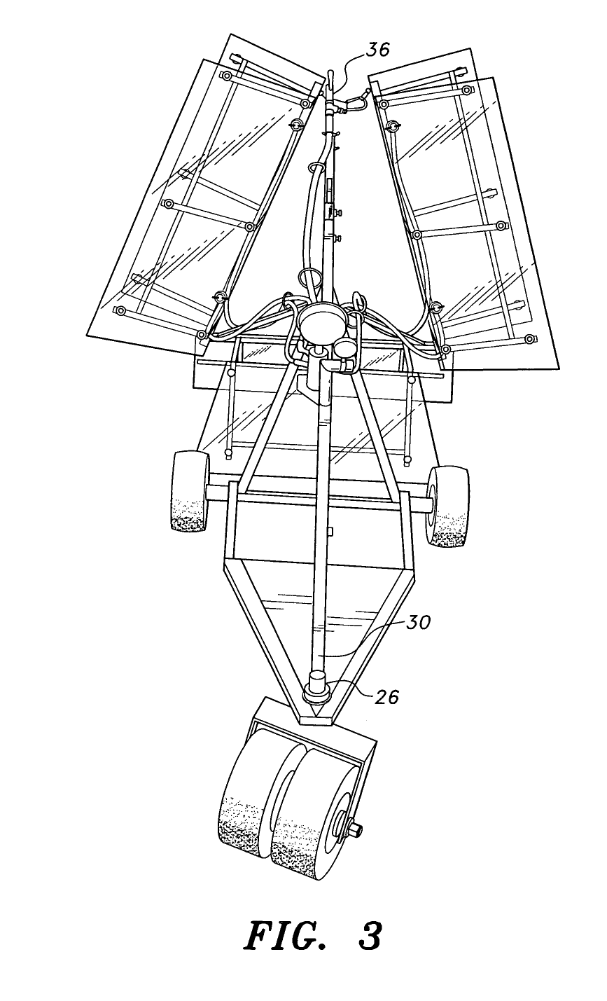

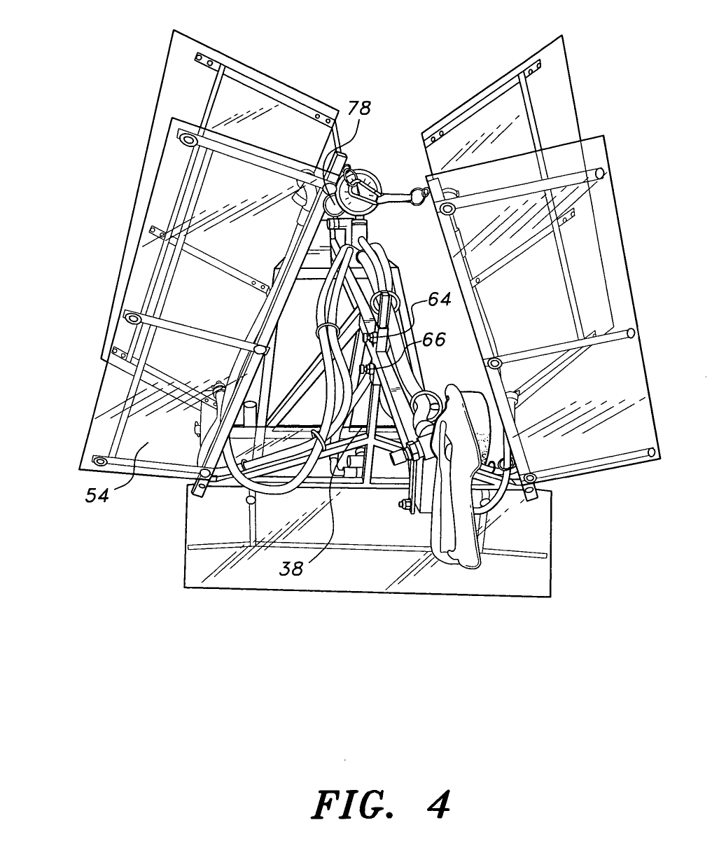

Referring to FIGS. 3 and 4, a front perspective and a rear perspective of the sprayer 2 are presented with the boom and boom panels folded for transportation. In FIG. 3 the continuity of the long shaft 30 can be observed from the front wheel rotatable shaft 26 to the operator's handle 36. The rear view depicted in FIG. 4 provides further insight into the disposition of the mechanism that allows the boom to be raised or lowered without disrupting the position of the operator's handle. The rod 38 passes through the box shaft 32 and is held in the selected position by fasteners 64 and 66, which, when relieved, permits the boom 10 and 10′ to be raised or lowered. FIG. 4 also depicts the screening covers in the folded or collapsed position.

The supporting structural components are preferably manufactured from steel, although aluminum and engineering plastics can be used for some elements of the chassis and support structure.

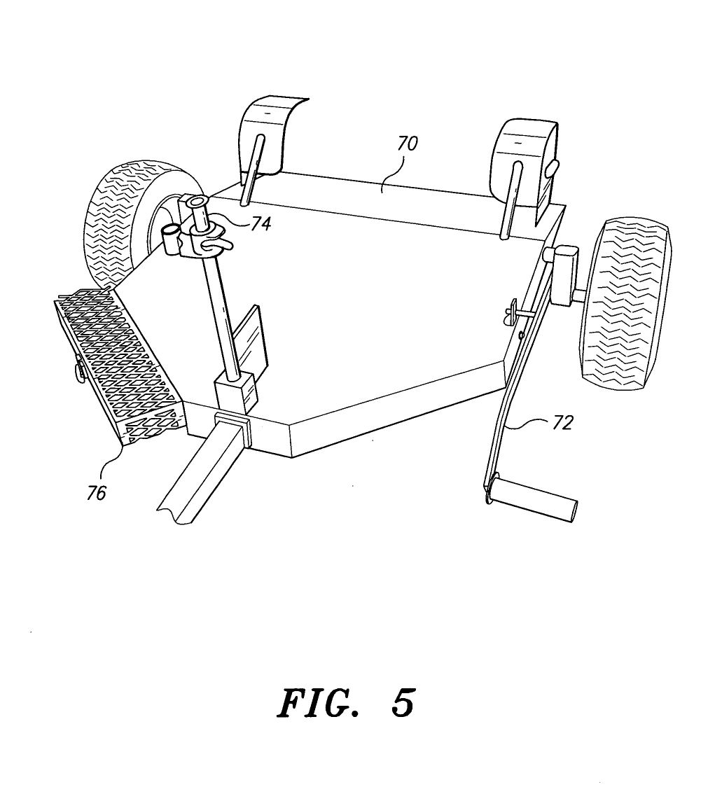

Referring to FIG. 5, the trailer 76 used to transport the walk behind sprayer 2 of the invention is depicted. The trailer 76 contains an elevated clamp and shaft 74 that connects to a forward section of the sprayer 2 of the invention to stabilize and secure the sprayer 2 when it is loaded on the trailer 76. The rear section 70 of the trailer 76 can be lowered or raised by means of an attached hinge connected to the trailer 76 and a rotatable handle 72. By lowering the rear section 70 of the chassis, the sprayer 2 can be readily pushed onto the trailer 76 and transported by towing with a vehicle.

It is to be understood that the present invention is not limited to the embodiments described above, but encompasses any and all embodiments within the scope of the following claims.

I claim:

1. A walk behind sprayer for treating grasses and soil with chemical liquids, comprising:
a chassis;
a triangular suspension having at least three rotatable wheels, the chassis being mounted on the suspension;
a foldable, hinged, hollow spraying boom connected to a rear part of the chassis behind said wheels, the boom having a plurality of liquid spray heads and a substantially vertical rod having a lower end connected to a midportion of the boom;
an elongated rod connected to and extending from a forward portion to a rear portion of the chassis;
means for movably containing and holding a top portion of said vertical rod in selected spraying boom positions;
a handle attached to the elongated rod for pushing the sprayer; and
means for starting and stopping flow of chemical liquids to said spray heads.

2. A trailer for transporting the walk behind sprayer of claim 1, comprising:
a platform chassis;
two wheel and tires supporting the chassis;
a hitch tongue extending from the chassis;
a platform mounted on the chassis having front and rear parts; and
a vertical rod at the front of the chassis for connecting to and holding the front of the sprayer.

3. The sprayer of claim 1 having three wheels with one wheel laterally turnable and rotatable placed in an extreme forward position of the chassis and two wheels placed rotatably forward of the boom.

4. The sprayer of claim 1 further comprising a plastic boom cover, wherein the boom supports said plastic boom cover which extends over the spray heads, whereby the pattern of liquid overspray is controlled.

5. The sprayer of claim 1 wherein the extreme ends of the foldably hinged, hollow spraying boom folds inward into a vertical position over the chassis for transportation.

6. The sprayer of claim 1 wherein said means for movably containing and holding a top portion of said vertical rod on said elongated rod comprises a short section of open sleeve rod releasable connected vertically to said elongated rod and having a cross-sectional area sufficiently greater than said vertical rod.

7. The sprayer of claim 1 wherein the means for passing chemical liquids to said spraying heads comprises tubing connected to a trigger on/off valve in the handle and to said spray heads, wherein a master liquid head connected to the tubing is connected to a remote reservoir of chemical liquid.

8. A walk behind sprayer for treating grasses and soil with chemical liquids, comprising:
a chassis;
a triangular suspension having at least three rotatable wheels, the chassis being mounted on the suspension;
a foldable, hinged, hollow spraying boom connected to a rear part of the chassis behind said wheels, the boom having a plurality of liquid spray heads and a substantially vertical rod having a lower end connected to a midportion of the boom;
an elongated rod connected to and extending from a forward portion to a rear portion of the chassis;
means for movably containing and holding a top portion of said vertical rod in selected spraying boom positions;
a handle attached to the elongated rod for pushing the sprayer;
means for starting and stopping flow of chemical liquids to said spray heads; and
a speedometer for allowing the operator to monitor the speed of travel over a surface being treated by the sprayer.

9. The walk behind sprayer of claim 8, wherein the speedometer has the additional functions of an odometer and a service timer, so that the operator can readily determine the total distance traveled, and also be alerted when the sprayer needs routine service.

10. The walk behind sprayer of claim 9, further comprising a pressure gauge, for monitoring the pressure at which chemical is applied, thus permitting the operator to maintain a proper spray rate, in combination with the speedometer.

11. The walk behind sprayer of claim 8, further comprising a pressure gauge, for monitoring the pressure at which chemical is applied, thus permitting the operator to maintain a proper spray rate, in combination with the speedometer.

12. A trailer for transporting the walk behind sprayer of claim 8, comprising:
a platform chassis;
two wheel and tires supporting the chassis;
a hitch tongue extending from the chassis;
a platform mounted on the chassis having front and rear parts; and
a vertical rod at the front of the chassis for connecting to and holding the front of the sprayer.

13. The sprayer of claim 8 having three wheels with one wheel laterally turnable and rotatable placed in an extreme forward position of the chassis and two wheels placed rotatably forward of the boom.

14. The sprayer of claim 8 further comprising a plastic boom cover, wherein the boom supports said plastic boom cover which extends over the spray heads, whereby the pattern of liquid overspray is controlled.

15. The sprayer of claim 8 wherein the extreme ends of the foldably hinged, hollow spraying boom folds inward into a vertical position over the chassis for transportation.

16. The sprayer of claim 8 wherein said means for movably containing and holding a top portion of said vertical rod on said elongated rod comprises a short section of open sleeve rod releasable connected vertically to said elongated rod and having a cross-sectional area sufficiently greater than said vertical rod.

17. The sprayer of claim 8 wherein the means for passing chemical liquids to said spraying heads comprises tubing connected to a trigger on/off valve in the handle and to said spray heads, wherein a master liquid head connected to the tubing is connected to a remote reservoir of chemical liquid.
